(19) United States
(12) Patent Application Publication
(10) Pub. No.: US 2020/0280050 A1
(43) Pub. Date: Sep. 3, 2020

(54) SILICON MICRO-REACTORS FOR LITHIUM RECHARGEABLE BATTERIES

(71) Applicants: Leon L. Shaw, Chicago, IL (US); Qianran HE, Chicago, IL (US); Maziar ASHURI, Chicago, IL (US)

(72) Inventors: Leon L. Shaw, Chicago, IL (US); Qianran HE, Chicago, IL (US); Maziar ASHURI, Chicago, IL (US)

(73) Assignee: ILLINOIS INSTITUTE OF TECHNOLOGY, CHICAGO, IL (US)

(21) Appl. No.: 16/646,251

(22) PCT Filed: Jan. 11, 2019
(86) PCT No.: PCT/US19/13261

§ 371 Date: Mar. 11, 2020

Related U.S. Application Data
(60) Provisional application No. 62/617,903, filed on Jan. 16, 2018.

(51) Int. Cl. H01M 4/1395; H01M 4/36; H01M 4/38; H01M 4/62; H01M 4/134; H01M 10/0525

(52) U.S. Cl. CPC H01M 4/1395; H01M 4/366; H01M 4/386; H01M 2004/027; H01M 4/134; H01M 10/0525; H01M 4/625

(57) ABSTRACT

Si micro-reactors and processes for fabrication thereof are provided. Such fabrication processing involves high-energy ball milling micro-sized Si particles with a first OPC mixture at first ball milling conditions to reduce the micro-sized Si particles to nanostructured particles and form Si+OPC clusters wherein the Si nanostructured particles are glued together by OPC. The Si+OPC clusters are high-energy ball milled with a second OPC mixture at second ball milling conditions to form a ball milled Si+OPC mixture wherein the Si+OPC clusters are injected into OPC particles. The ball milled Si+OPC mixture is treated at carbon shell formation conditions to convert OPC to carbon shells and to form Si nanostructured particles coated with a carbon shell. The Si core of the Si nanostructured particles coated with a carbon shell are chemically etched under chemical etching conditions to generate engineering voids in the shape of nano-channels inside the carbon shell and to form Si micro-reactors.

### CROSS REFERENCE TO RELATED APPLICATION

This patent application claims priority to, and the benefit of, U.S. Provisional Patent Application Ser. No. 62/617,903, filed on 16 Jan. 2018. The co-pending Provisional Application is hereby incorporated by reference herein in its entirety and is made a part hereof, including but not limited to those portions which specifically appear hereinafter.

### STATEMENT REGARDING FEDERALLY SPONSORED RESEARCH OR DEVELOPMENT

This invention was made with government support under grant NSF CMMI-1660572 awarded by the National Science Foundation. The government has certain rights in the invention.

### FIELD OF THE INVENTION

This invention relates generally to lithium ion batteries and, more particularly, to silicon anodes for such batteries. The invention more specifically relates to novel silicon micro-reactors and methods of fabrication thereof such as desirable for use in or the manufacture of silicon anodes for such batteries.

### BACKGROUND OF THE INVENTION

Li ion batteries (LIBs) have revolutionized portable electronic devices in the past two decades, and have the potential to make great future impacts in a variety of areas including vehicle electrification. In spite of their eminent potential, state-of-the-art Li-ion batteries (such as LiCoO₂/graphite batteries) have not been able to satisfactorily satisfy the needs and demands of or for vehicle electrification, such as including the need for both high energy density and high power density and, simultaneously provide a long cycle life. Therefore, batteries with high energy density, high power density and long cycle life are in urgent demand to address the problems, issues and challenges faced by LIBs in providing desired driving range or distance and providing desirably rapid charging or recharging.

In this context, silicon is one of the most promising anode candidates for next-generation Li-ion batteries. This is largely due to silicon's low voltage profile and high theoretical capacity (3590 mA h g⁻¹ for Li₁₅Si₄ phase at room temperature), which is about ten times that of carbonaceous materials including graphite, pyrolytic carbon and meso-phase pitch (about 372 mA h g⁻¹). In addition, silicon is the second most abundant element in the earth's crust. Therefore, mass production utilization of silicon with low cost is not an issue. The practical application of silicon anodes, however, is currently hindered by multiple challenges including the enormous volume change (˜300%) such as experienced or associated with or during lithiation/delithiation processes, low intrinsic electrical conductivity, and instability of the solid electrolyte interphase (SEI). The large volume change can result in particle pulverization, loss of electrical contact with the conductive additive or current collector, and even peeling off from an associated current collector. Repeated volume expansion and shrinkage can lead to fracture and re-formation of the SEI layer around the particles, resulting in continuous consumption of the electrolyte, increased impedance, and capacity fading.

Significant efforts have been devoted to addressing the issues mentioned above. The strategies investigated have been described in many journal publications, issued patents, and patent applications. The strategies described in journal publications include Si material design through nanostructures, porous structures, or nanocomposites, Si electrode design with combined nano- and micro-particles or with 3D micro-channels, addition of electrolyte additives, and use of novel binders. These strategies have resulted in significant advancements in Si anode performance. For example, high specific and volumetric capacities at 1160 mA h g⁻¹ and 1270 mA h cm⁻³, respectively, after 1000 cycles at the current density of 1.2 A/g accomplished through a pomegranate-inspired nanoscale design have been reported. An exceptionally high specific capacity of ˜1400 mAh/g after 1000 cycles at the current density of 2.2 A/g was reportedly achieved through a Si@void@C yolk-shell structure (which has void space between a Si core and the outer C shell). Another outstanding example reports that a high capacity of 1200 mAh/g over 600 charge/discharge cycles at the current density of 1.2 A/g could be obtained through micro-sized porous Si material. Together, these examples reveal unambiguously that Si anodes with combined features of nanoscale Si building blocks, conductive coatings and engineered void space can improve Si performance.

In parallel with significant advancements reported in journal publications, many patents and patent applications have disclosed innovative strategies and/or approaches to address some of the significant challenges faced by Si anodes. Specifically, the following patents and patent applications may be relevant to the subject invention development:

U.S. Pat. No. 9,698,410, issued Jul. 4, 2017, discloses seeking to achieve high performance electrodes via a composite structure containing high capacity porous active materials (such as Si) constrained in shells. No electrochemical performance data, however, is provided.

U.S. Pat. No. 9,548,490, issued Jan. 17, 2017, discloses an anode material (such as Si) with multi-layer coatings to enhance anode performance. The capacity retention is reported to be improved to 80% after 100 cycles through these multi-layer coatings.

U.S. Pat. No. 9,196,896, issued Nov. 24, 2015, discloses a porous Si-based electrode comprising a Si phase, a SiOₓ (0<x<2) phase and a SiO₂ phase to improve charge/discharge performance of Si anodes.

U.S. Pat. No. 9,184,438, issued Nov. 10, 2015, discloses a process for etching Si to form Si pillars for use as anodes in Li-ion batteries. However, no electrochemical performance data is provided.

U.S. Pat. Application Publication 2017/0170477, filed Aug. 26, 2016, discloses a process for depositing Si into the pore space of a porous scaffold material (such as porous carbon) to achieve high durability for lithiation and delithiation of Si anodes.

In spite of so many methods and strategies to improve Si anode performance disclosed in the prior art, none of the prior technologies can achieve 1000 mAh/g specific capacity at the current density of 6.0 A/g over 500 cycles. Therefore, there is a need for new processing methods to obtain better Si anodes that can deliver desired or required capacity while also providing or supplying desirably rapid charging and cycle stability, such as providing or resulting in 170% more specific capacity than the state-of-the-art carbonaceous anodes while being capable of completing charge to full capacity in 10 min with 500 charge/discharge cycle stability.

### SUMMARY OF THE INVENTION

In accordance with one aspect of the subject development, there is provided a new method or process for the fabrication of a large quantity of Si micro-reactor particles with superior electrochemical performance at low costs.

In accordance with another aspect of the subject development, there is provided novel Si micro-reactor particles such as produced or manufactured by such process.

As detailed further below, the subject novel technology can achieve 1000 mAh/g specific capacity at the current density of 6.0 A/g over 500 cycles. In other words, the Si anodes fabricated using the subject technology can deliver 170% more specific capacity than the state-of-the-art carbonaceous anodes while being capable of completing charge to the full capacity in 10 min with 500 charge/discharge cycle stability.

In addition, the subject inventive technology is a low cost process and scalable in or for an industrial environment, making the manufacture of high performance Si anodes at large scales and low costs possible. Specifically, in accordance with one preferred embodiment, the subject manufacturing process starts with high-energy ball milling of micro-sized Si particles (FIG. 2). High-energy ball milling is an industry-used method to fabricate large-scale nanomaterials, thereby allowing tonnage of Si nanostructured particles to be fabricated. This also avoids the use of expensive Si nanoparticles which are normally synthesized through laser irradiation and chemical vapor deposition. Etching of partial Si after carbon shell formation using NaOH aqueous solution is safer than etching of SiO₂ using HF aqueous solution reported by many groups. Finally, the entire manufacturing process and powder handling can be carried out in ambient environment except (i) the carbon shell formation via carbonization of polyacrylonitrile (PAN) which requires an argon atmosphere and (ii) an argon atmosphere during high-energy ball milling, but not during powder loading and unloading. Because powder loading and unloading in all processing steps can be conducted in ambient environment, the manufacturing method of the subject development is scalable in or for industrial environment.

### BRIEF DESCRIPTION OF THE DRAWINGS

FIG. 1 is a simplified schematic showing of the microstructure and composition changes of the Si micro-reactors during lithiation and delithiation in accordance with one aspect of the subject invention development.

FIG. 2 is a simplified schematic showing a manufacturing process for synthesizing Si micro-reactors in accordance with one preferred embodiment of the subject invention development.

FIG. 3a-f are scanning electron microscopy (SEM) images of:
a. micro-sized Si particles before high-energy ball milling,
b. micro-sized PAN particles before high-energy ball milling,
c. micro-sized Si+5 wt % PAN after high-energy ball milling for 10 hours,
d. a higher magnification of image (c),
e. 10 h ball milled Si+PAN after high-energy ball milling with additional 20 wt % PAN for 1 hour, and
f. nano-Si particles+25 wt % PAN after high-energy ball milling for 1 hour.

FIG. 4a-b are SEM images of carbon-coated Si particles after conversion of PAN to carbon at 900° C. in Ar with:
a. showing a two-step high-energy ball milled micro-sized Si, and
b. showing a one-step high-energy ball milled Si nanoparticles.

FIG. 5 illustrates Raman spectra of Si at different stages of processing with different conditions.

FIG. 6a-b are TEM images of Si@void@C5B (i.e., Si@C core-shell structure after chemical etching at 50° C. for 20 min) with:
a. a bright-field image, and
b. an elemental map of particles in FIG. 6a.

FIG. 7a-c are graphical depiction of:
a. the charge/discharge voltage profiles of a Si micro-reactor anode (Si@void@C) in accordance with one embodiment of the invention,
b. the specific charge/discharge capacities and coulombic efficiency of a Si@void@C anode as a function of cycle numbers in accordance with one embodiment of the invention, and
c. the specific charge/discharge capacities and coulombic efficiency of a Si@C anode as a function of cycle numbers in accordance with one embodiment of the invention.

FIG. 8a-c are graphical depictions of the specific capacities and coulombic efficiencies, respectively, of various Si-based half cells as follows:
a. Si micro-reactors (Si@void@C),
b. nanoSi@void@C, and
c. Si@void@C but the carbon shell is formed via carbonization of pyrrole rather than PAN.

FIG. 9 is a graphical representation of specific capacities and coulombic efficiencies of Si micro-reactors (Si@void@C) under extreme fast charging/discharging conditions in accordance with one embodiment of the present development.

FIG. 10a-b are TEM images of:
a. Si@C before etching and
b. Si@void@C after etching.

FIG. 11 is a simplified schematic of ultrafast charging of Si@void@C with an enlargement of a Si@void@C particle.

FIG. 12 is a graphical representation of coulombic efficiencies and specific capacities of Si@void@C as a function of cycle number.

### DETAILED DESCRIPTION

As detailed below, there is provided, in accordance with one aspect of the subject development, a new process such as to permit fabrication of a large quantity of Si micro-reactor particles with superior electrochemical performance at low costs.

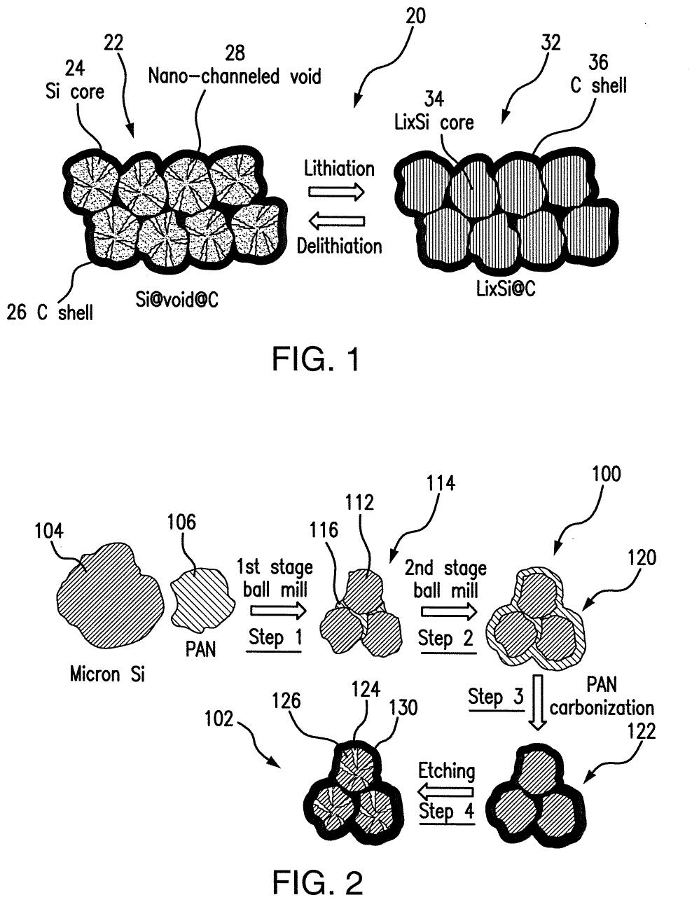

FIG. 1 is a simplified schematic, generally designated by the reference numeral 20, showing Si micro-reactors 22 (denoted as Si@void@C hereafter), in accordance with one preferred practice of the subject development. The Si micro-reactors 22 contain well-designed structures, including (i) nanostructured Si building blocks 24 as the core of Si micro-reactors, (ii) a conductive carbon shell 26, and (iii) engineered voids 28 in the shape of nano-channels inside the carbon shell 26.

FIG. 1 shows the microstructure and composition changes of the Si micro-reactors 22 associated with lithiation and delithiation in accordance with one aspect of the subject invention development. It is noted that Si expansion and shrinkage take place within the carbon shell, thereby offering a stable electrode/electrolyte interface for the formation of stable SEI layers and maintaining good contact with conductive additives and the current collector for long-lasting cycle life. The engineered void in the nano-channeled shape makes ultrafast charging possible.

With lithiation (forming LixSi@C) 32, the core 34 within the carbon shell 36 becomes LiₓSi.

Such hierarchical Si micro-reactors, such as in accordance with one embodiment with outer diameters ranging from 100 to 500 nm, can offer many advantages over Si nanoparticles, carbon-coated Si nanoparticles, and micro-sized Si particles with and without carbon coatings. Such advantages, for example, may include and are not necessarily limited to one or more of the following:

First, particle sizes such as in the range of 100 to 500 nm can provide large surface areas for rapid Li intercalation into the Si micro-reactor, while permitting high tap density and high mass loading of Si micro-reactors in the anode. Such particle sizes also can desirably serve to shorten the solid-state diffusion distance of Li⁺ ions inside the Si core during lithiation and delithiation processes. Second, the porous nature of the carbon shell of such structures can desirably further allow fast or rapid Li⁺ ion transport and can thus desirably minimize or preferably avoid Li plating on the surface of the carbon shell during extreme fast charging. Third, the carbon shell of such structures may desirably fulfill or provide one or more additional functions such as (i) offering a super highway for electron transport to address the low intrinsic electrical conductivity issue of Si and/or (ii) confining the Si volume expansion and shrinkage inside the carbon shell during charge/discharge cycling, such as to thereby provide a stable electrode/electrolyte interface for the formation of stable solid electrolyte interphase (SEI) layers, thus minimizing, reducing or avoiding stresses to the binder, minimizing, reducing or avoiding electrode pulverization, and desirably maintaining good contact with the current collector such as for or conducive to long-lasting cycle life. Fourth, engineered voids inside the carbon shell (FIG. 1) will allow Si volume expansion during lithiation and desirably without causing fracture of the carbon shell, thereby a stable electrode/electrode interface and SEI layer for long cycle life. Furthermore, the inclusion of engineered voids in the shape of nano-channels, rather than the conventional spherical voids or bulky voids between the Si core and the outer shell as described in some publications and in U.S. Pat. No. 9,698,410, will allow lithium ion intercalation into and de-intercalation from the nanostructured Si very quickly and thus ultrafast charging and discharging of batteries (such as charge to the full capacity in 5 to 20 min).

The invention will be described and illustrated below making specific reference to processing with PAN, e.g., high-energy ball milling in two steps with PAN. Those skilled in the art and guided by the teachings herein provided will understand and appreciate that Si micro-reactors can also be achieved by high-energy ball milling of other organic precursors for carbon (OPC) in two steps as described and illustrated below with PAN. Examples of other organic precursors suitable for use in the practice of the subject development include pitches, rayon, polyvinyl alcohol, polyimides, phenolics, and acetate.

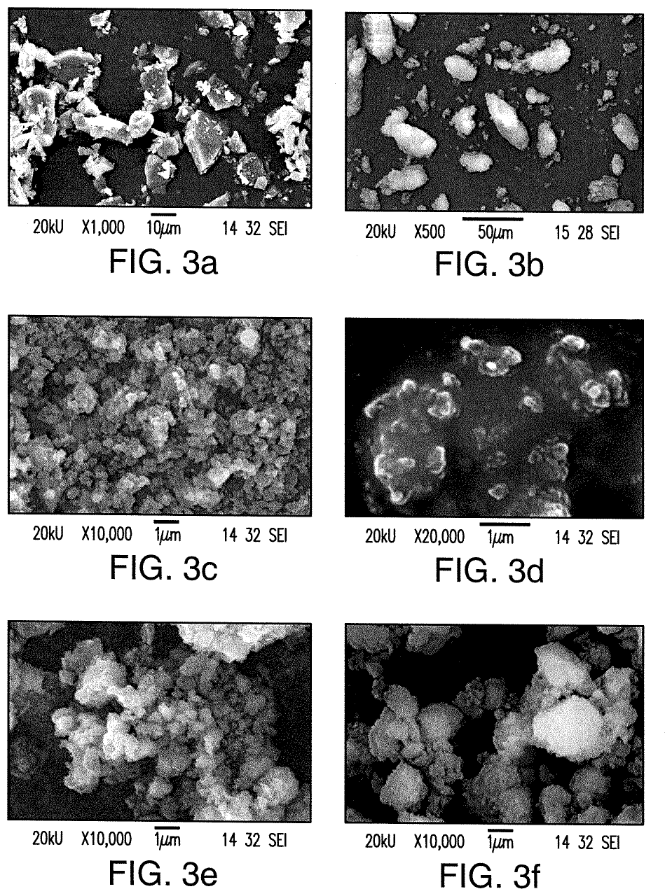

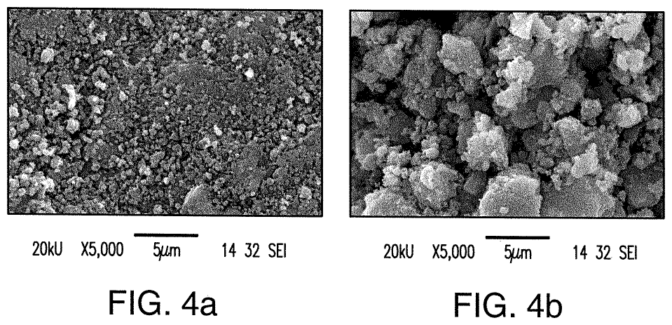

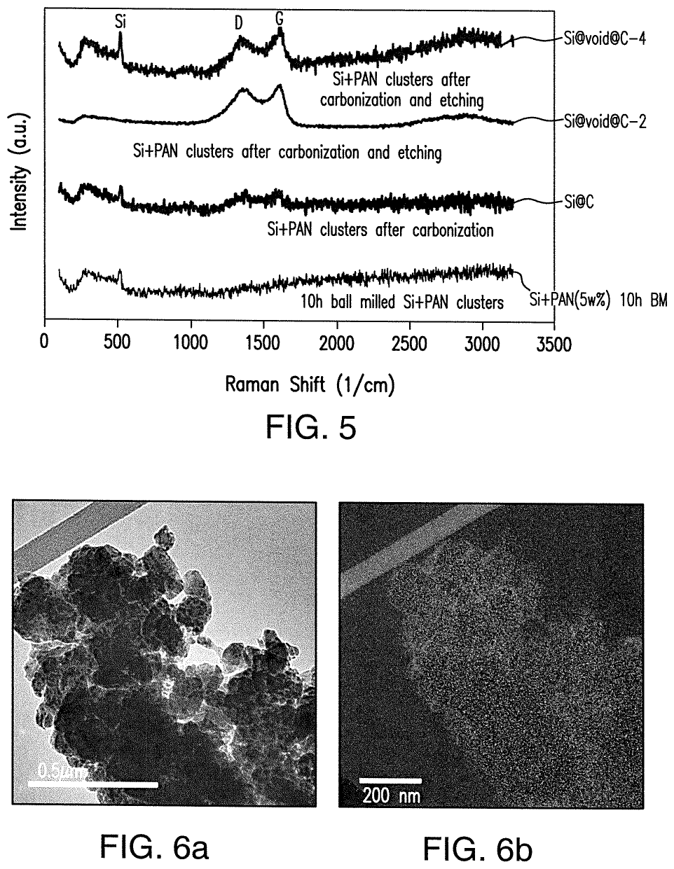

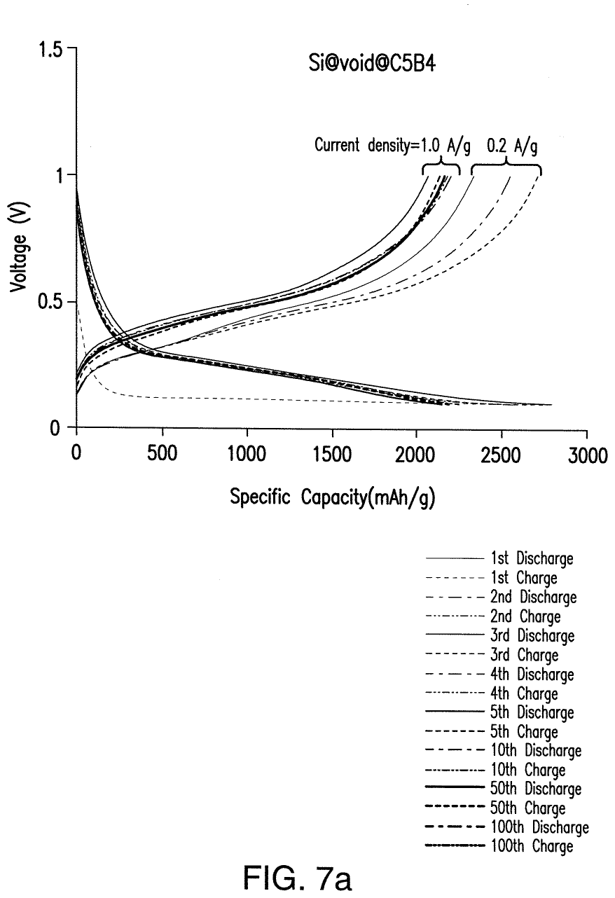

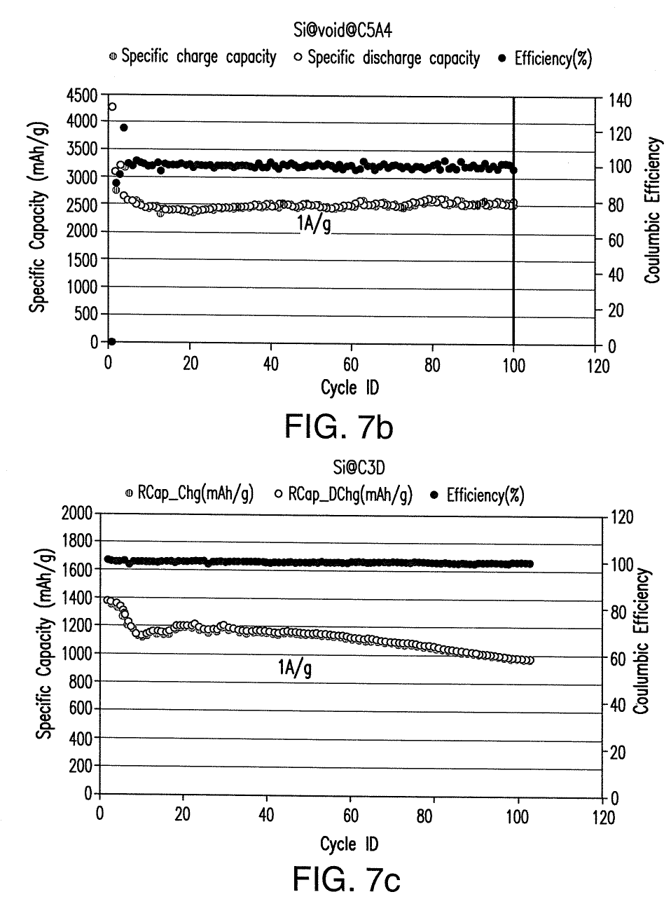

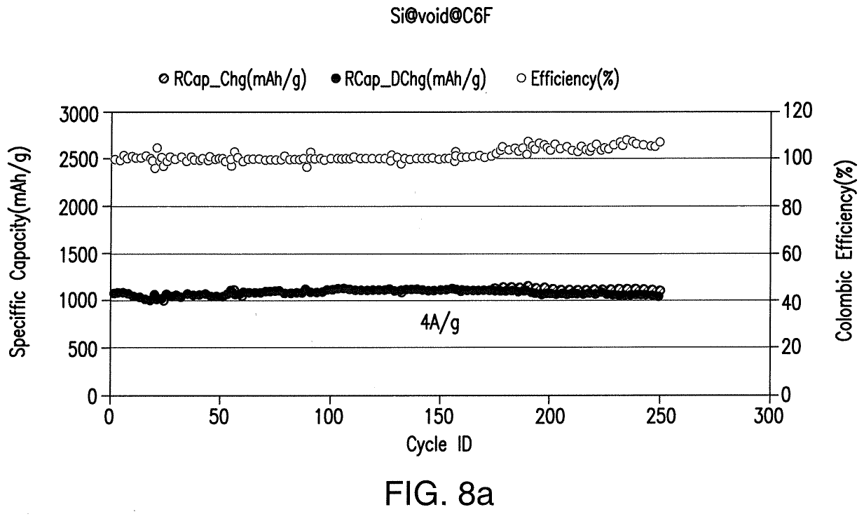

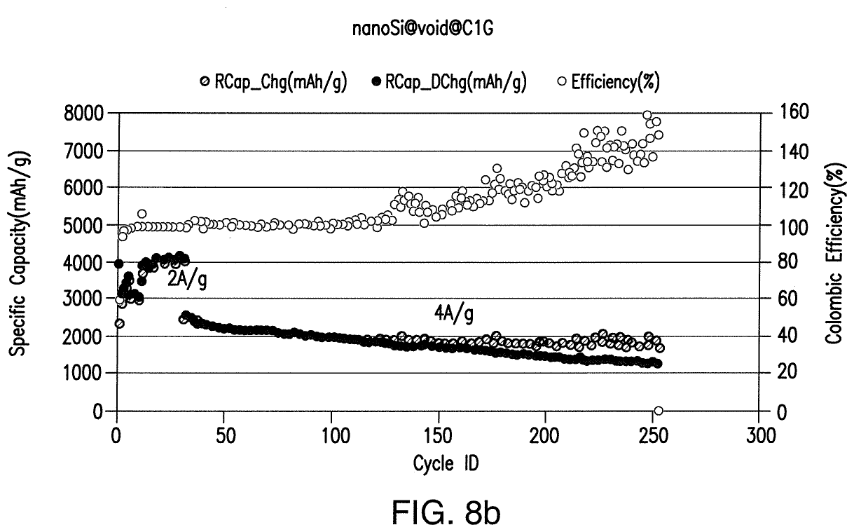

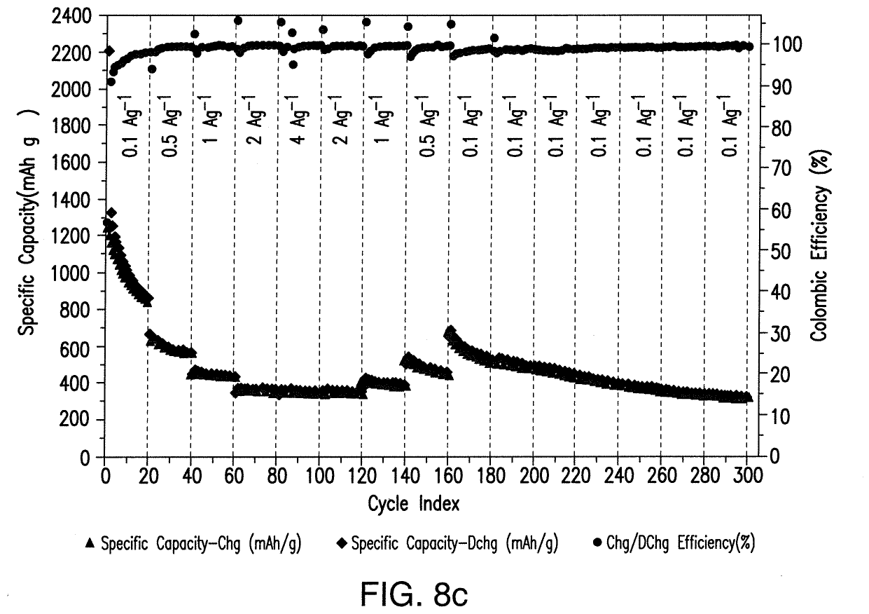

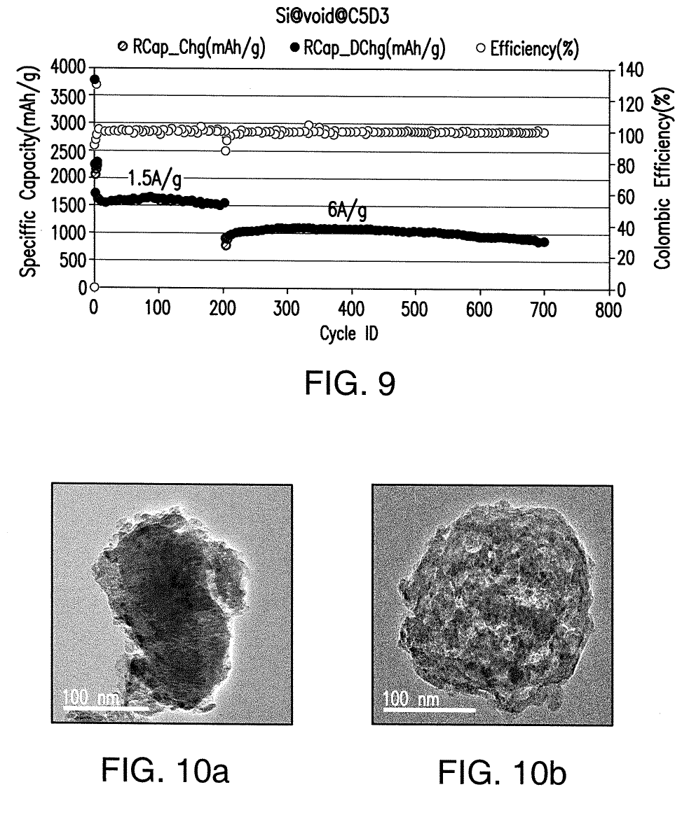

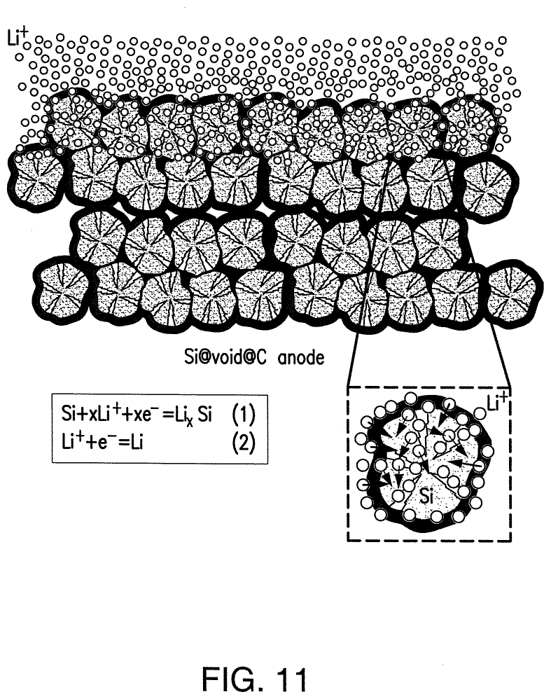

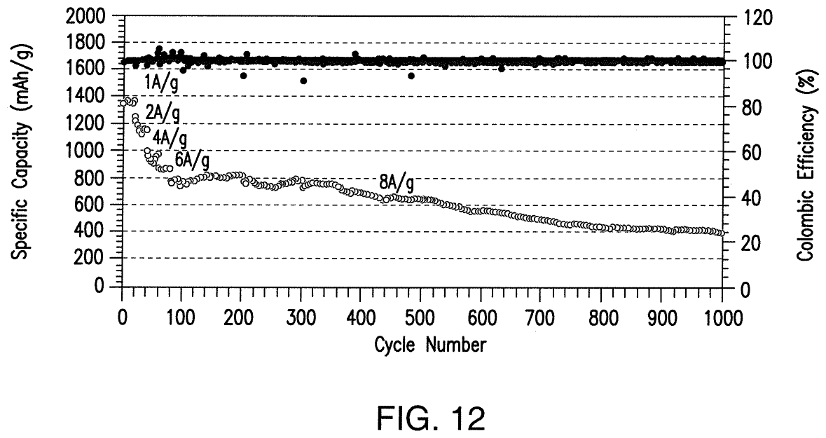

FIG. 2 shows a manufacturing process, generally designated by the reference numeral 100, in accordance with one preferred embodiment of the invention, for fabricating Si micro-reactors 102. As shown, a first step of such process is high-energy ball milling of Si particles 104, such as commercially available micro-sized Si particles (e.g., about 10 to 20 μm in size as shown in FIG. 3a) with a small amount of PAN 106 to reduce the micro-sized Si particles 104 to nanostructured particles 112 (with particle sizes ranging from 100 to ˜500 nm and containing nanograins with grain sizes of 5 to 90 nm) and at the same time leads to the formation of Si+PAN clusters 114 of about 1 to 3 μm in size within which the Si nanostructured particles 112 are glued together by PAN 116 (FIGS. 3c and 3d). In one embodiment, such processing may for example involve high-energy ball milling of the Si particles 104 with 5 w % PAN 106 for 3 to 30 hours at ambient temperature under an Ar atmosphere.

The second step of the manufacturing process is high-energy ball milling of the Si+PAN clusters 114 with additional PAN, typically about 10 to 40 wt % PAN. For example, such additional processing may involve high-energy ball milling 10h-ball milled Si+PAN clusters with another 20 wt % PAN for 1 to 10 hours. This step will desirably serve to inject the 10 h-ball milled Si+PAN clusters into large and ductile PAN particles forming a ball milled Si+PAN mixture wherein the Si+PAN clusters are injected into PAN particles 120. Such a ball milled Si+PAN mixture wherein the Si+PAN clusters are injected into PAN particles may desirably serve to satisfy or accomplish one or more and preferably all three of the following objectives simultaneously:

(a) generation of Si nanostructured particles from low cost micro-sized Si particles through selective and particular application of a widely used industry process,

(b) coat every Si nanostructured particle with PAN by injecting Si nanostructured particles into ductile PAN particles, and

(c) load a sufficient quantity of PAN to later form carbon shells of sufficient desired thickness.

The third step is carbonization step such as involving heating the ball milled Si+PAN mixture 120 in an Ar atmosphere between 500 and 1000° C. for 1-15 hours to convert PAN to carbon shells. This step leads to the formation of Si nanostructured particles coated with a carbon shell 122 (denoted as Si@C hereafter).

The next step of the subject manufacturing process is chemical etching of partial Si core from the Si@C core-shell particles 122. This is accomplished using a chemical etchant such as 0.5M or 1.0M NaOH+10 wt % isopropanol, for example, and carried out at chemical etching conditions such as at a temperature in a range of 20 to 90° C. This step generates at least some engineered voids 124 in the Si core 126, the voids 124 being in the shape of nano-channels inside the carbon shell 130 and thus the formation of Si micro-reactors 102 (denoted as Si@void@C). The etched particles can then be washed such as at room temperature using deionized water, dried such as in vacuum at 100° C. for overnight, and finally stored such as in a container for later use.

It should be emphasized that high-energy ball milling of Si and PAN is essential for the formation of uniform carbon shells and thus superior charge/discharge properties. Simple mixing of Si and PAN particles will not result in uniform carbon shells that can fully encapsulate the Si core. Furthermore, two-step high-energy ball milling is critical in generating Si nanostructured particles which have particle sizes from 100 to ˜500 nm and which also contain Si nanograins with grain sizes in the range of 5 to 90 nm along with uniform carbon shells of sufficient thickness. The Si nanostructured particles of this embodiment of the invention can be simply described as submicron-sized particles (≥100 nm) with nanograins of 5 to 90 nm inside the particles.

One-step high-energy ball milling of micro-sized Si particles such as with 25 wt % PAN (i.e., 40 vol % PAN) cannot lead to the formation of Si nanostructured particles because micro-sized Si particles will be injected into ductile PAN particles and little or no Si particle size reduction can be achieved within a reasonable ball milling time. Furthermore, no nanostructured Si particles can be formed. The forming of nanostructured particles requires repeated fracture and cold welding of powder particles during high-energy ball milling. Addition of a large amount of ductile PAN (such as 10 to 40 vol. % PAN) prevents repeated fracture and cold welding of Si particles during high-energy ball milling and thus precludes the formation of Si nanostructured particles within reasonable ball milling times (such as 5 to 35 hours). Prolonged ball milling times (e.g., 40 to 100 hours) in the presence of 40 vol. % or more PAN may result in the formation of Si nanostructured particles, but also introduces significant Fe contamination due to wear of steel balls used in high-energy ball milling. Significant Fe contamination will undoubtedly deteriorate Si anode performance.

Two-step high-energy ball milling is also critical in the formation of a uniform carbon shell on every Si nanostructured particle. Repeated deformation, fracture and cold welding of Si (95 wt %) and a small quantity of PAN (5 wt %) during high-energy ball milling can lead to uniform coating of PAN on every Si nanostructured particle and binding several Si nanostructured particles together by PAN to form Si+PAN clusters as shown in FIGS. 3(c) and 3(d). Uniform PAN coating at this stage plays a critical role in preventing Si nanostructured particle growth and agglomeration in the later carbonization of PAN to form carbon shells at high temperatures (e.g., 500 to 1000° C.). As will be demonstrated in Example 2 below, high-energy ball milling of commercial Si nanoparticles with 25 wt % PAN directly results in Si nanoparticle growth and agglomeration in the PAN carbonization process. As a result, such Si anodes exhibit poor electrochemical behavior in comparison to Si micro-reactor anodes with well controlled hierarchical structure.

Proper etching and washing conditions are also key to the high performance Si micro-reactors. The major parameters for chemical etching of partial Si core in the Si@C core-shell structure include etching temperature, etching time, washing temperature, washing time and etchant composition. Due to the high surface area of Si micro-reactors, which is about 20 m²/g, the etching temperature has to be controlled very carefully. Etching temperatures ranging from 25 to 90° C. could lead to very different degrees of etching. Etching temperatures ranging from 50 to 70° C. typically generates the best engineered voids for different Si micro-reactors. Etching of Si with a NaOH aqueous solution proceeds with a series of oxidation and reduction reactions, including the following steps:

(1) Oxidation of Si by hydroxyl radicals to form silicate: Si+2OH⁻+4H+→Si(OH)₂²⁺
(2) Reduction of water: 4H₂O→4OH⁻+2H₂+4H⁺
(3) Formation of a water-soluble complex: Si(OH)₂²⁺+4OH⁻→SiO₂(OH)₂²⁻+2H₂O

Therefore, it is expected that higher etching temperature and longer etching time will result in more etching of Si. Furthermore, the reaction kinetics of etching can be qualitatively judged based on how fast hydrogen gas evolves during the experiment. All of these expectations have been confirmed experimentally.

As shown in Table 1, Si@void@C-1 and Si@void@C-2 samples have lower Si contents and higher O concentrations when compared with other Si@void@C samples because these two samples are etched at 80° C. which is higher than the etching temperature used for other Si@void@C samples (50° C. only). A comparison between Si@void@C-1 and Si@void@C-2 reveals that longer washing time leads to lower Si contents, suggesting that the washing process using deionized water can also etch Si although the etching rate is much slower than the NaOH aqueous solution. A comparison between Si@void@C-3 and Si@void@C-6 samples also corroborates this trend.

TABLE 1
Energy-dispersive spectroscopy (EDS) data for Si micro-reactors with different etching and washing conditions.

| | | | | | | | 0.5M NaOH, |
|---|---|---|---|---|---|---|---|
| | | | | | | 1.0M of | 50 C. 20 min |
| | | | 0.5M NaOH, | | 0.5M NaOH | NaOH + 10% | wash with RT |
| | | 0.5M NaOH | 80 C. 20 min | 0.5M NaOH | 10% 2- | 2-propanol, | DI water 3 |
| | | 80 C. 20 min | wash with DI | 50 C. 20 min | propanol 50 C. | 50° C. 20 min, | days change |
| | Before | wash with DI | water at 80° C. | wash with DI | 20 min wash | wash with DI | water each |
| | etching | water[3] | 6 h for 3 times | water | with DI water | water | day |
| w % | Si@C | Si@void@C-1 | Si@void@C-2 | Si@void@C-3 | Si@void@C-4 | Si@void@C-5 | Si@void@C-6 |
| C K | 26.93 | 44.90 | 59.06 | 39.66 | 37.82 | 39.19 | 52.54 |
| O K | 6.89 | 23.63 | 18.83 | 7.42 | 7.32 | 9.61 | 14.29 |
| Na K | 0.00 | 1.33 | 0.39 | 0.04 | 0.00 | 0.28 | 0.00 |
| Si K | 65.11 | 27.43 | 20.24 | 51.90 | 53.53 | 49.71 | 31.95 |
| Fe K | 1.08 | 2.70 | 1.47 | 0.97 | 1.33 | 1.21 | 1.22 |
| Total | 100.00 | 100.00 | 100.00 | 100.00 | 100.00 | 100.00 | 100.00 |

Electrochemical experiments revealed that Si@void@C-1 and Si@void@C-2 electrodes do not offer good specific capacity and cycle stability because they are over-etched. In contrast, Si@C etched at 50° C. (such as Si@void@C-3, Si@void@C-4 and Si@void@C-5) can provide moderate etching and thus superior specific capacity and cycle stability. Addition of 10 vol % 2-propanol to the NaOH aqueous solution can make etching more uniform and thus uniform Si content in each Si micro-reactor. The improved uniformity is due to the fact that Si is hydrophobic and the mixed H₂O/2-propanol solvent can improve the wettability of the etchant on the surface of Si nanoparticles, thereby uniform etching on every Si nanoparticle.

Finally, the nanostructure inside the Si particles of 100 to −500 nm generated via the two-step high-energy ball milling is essential in generating engineered voids in the shape of nano-channels. The grain boundaries between Si nanograins within a nanostructured Si particle are thermodynamically and chemically very active and thus will be etched away first in the etching process, creating nano-channeled voids rather than conventional spherical voids or bulky voids between the Si core and the outer shell. The engineered voids in the shape of nano-channels will allow fast Li-ion transport within the Si core and thus enable ultrafast charge/discharge of Si@void@C anodes, as described in Examples 4, 5 and 6.

In what follows, several examples are provided in order to provide a more facile understanding of the present invention. It should be noted that these examples are for the illustrative purpose only. Those skilled in the art will recognize that there are numerous modifications and variations to obtain Si micro-reactors with superior electrochemical performance, and that the present invention is not limited to such examples.

### EXAMPLES

### Example 1 (High-Energy Ball Milling of Si and PAN Mixtures)

Micro-sized Si particles (10 to 20 μm) are mixed with PAN particles (10 to 50 μm) in a weight ratio of 95% to 5% (i.e., 90.6 vol % Si with 9.4 vol % PAN), loaded into a canister with steel balls at a ball-to-powder weight ratio of 20:1, and then sealed in an Ar-filled glovebox. The SEM images of the micro-sized Si particles and PAN particles are shown in FIG. 3a and FIG. 3b, respectively. The loaded canister is then transferred to a SPEX 8000 Mill and subjected to 10-hour high-energy ball milling. To avoid overheating and thus prevent caking, milling is stopped for 10 min after each 1-h milling. After high-energy ball milling the canister is transferred to the Ar-filled glove box for unloading. This processing step has reduced micro-sized Si particles to nanostructured particles of 100 to 300 nm. Furthermore, these Si nanostructured particles are glued together by PAN to form Si+PAN clusters of 1 to 3 μm in size, as shown in FIG. 3c and FIG. 3d.

The 10 h-ball milled Si+PAN clusters are mixed with another 20 wt % PAN powder and high-energy ball milled for 1 hour. This step results in the formation of Si+PAN clusters of 1 to 5 μm in size, as shown in FIG. 3e. Compared with those 10 h-ball milled Si+PAN clusters, these new clusters after addition of 20 wt % PAN and additional 1 h ball milling are slightly larger (changing from 1-3 μm to 1-5 μm). At this stage all Si nanostructured particles formed in the first high-energy ball milling step are coated very well with PAN, which can result in uniform carbon shells on every Si nanostructured particle in the later PAN carbonization process.

For comparison, commercially available Si nanoparticles of 50 to 70 nm were mixed with 25 wt % PAN (i.e., 40 vol % PAN) directly and high-energy ball milled for 1 h under the same ball milling conditions as the micro-sized Si described above. The product from this process was Si+PAN clusters of 1 to 10 μm, as shown in FIG. 3f. It should be emphasized that these Si+PAN clusters were larger than those produced from micro-sized Si with two-step high-energy ball milling. Furthermore, the Si nanoparticles from this one-step ball milling were not completely coated with PAN because nanoparticles have a strong propensity to agglomerate. These nanoparticle agglomerates were now glued together by PAN. As a result, not every individual nanoparticle was coated with PAN. In sharp contrast, every Si nanostructured particle produced from micro-sized Si was coated with PAN due to the first step high-energy ball milling, which accomplishes two purposes simultaneously: (i) generation of Si nanostructured particles and (ii) coat every Si nanostructured particle with PAN via gluing nanostructured particles together by PAN.

Uniform PAN coating at this stage plays a critical role in preventing Si nanostructured particle growth and agglomeration in the later carbonization of PAN to form carbon shells at high temperatures (500 to 1000° C.). As will be demonstrated in Example 2 below, high-energy ball milling of Si nanostructured particles with 25 wt % PAN directly results in Si nanoparticle growth and agglomeration in the PAN carbonization process. As a result, such Si anodes exhibit poor electrochemical behavior in comparison to the Si micro-reactor anodes produced from two-step high-energy ball milling.

### Example 2 (Carbonization of PAN to Form Carbon Shells)

The Si+PAN clusters obtained from Example 1 above were heated to 900° C. in Ar with a heating rate of 5° C./min and held at that temperature for 5 h. This process converts PAN to carbon shells with the formation of carbon-coated Si particles. However, the two types of Si particles obtained from Example 1 had significant particle sizes. As shown in FIG. 4, the carbon-coated Si derived from the two-step high-energy ball milled micro-sized Si had particle sizes that were much smaller than those derived from the one-step high-energy ball milled Si nanoparticles. The significant difference in particle sizes was due to the fact that the two-step high-energy ball milled Si nanostructured particles had uniform PAN coating before heating. This uniform PAN coating converted to uniform carbon shells during heating and prevents Si nanostructured particles from growth. As a result, the two-step high-energy ball milled Si exhibited very uniform and small (300 nm to 1 μm) particle sizes. In contrast, one-step high-energy ball milled Si nanoparticles were grown to become very large particles of non-uniform sizes (500 nm to 6 μm). This un-intuitive result is due to the fact that not every Si nanoparticle was coated with PAN before heating even though all Si agglomerates composed of primary Si nanoparticles were glued by PAN. In this case, many Si nanoparticles were agglomerated and contacted each other directly before heating. Because of the absence of PAN between many Si nanoparticles, most Si agglomerates grew into large particles even though the surfaces of the agglomerates were coated with PAN before heating. Large Si particles will result in large volume expansion per particle during lithiation and thus very poor charge/discharge properties, as will be discussed in Example 4.

The conversion of PAN to carbon was confirmed by Raman spectroscopy. As shown in FIG. 5, 10 h high-energy ball milled Si+PAN clusters do not have typical D band and G band of graphitic carbon, but a Si peak at −500 cm⁻¹ was present. After 5 h heating at 750° C., D band and G band started to show up, indicating the formation of carbon. After chemical etching of partial Si, D band and G band peaks became stronger because of the reduced Si concentration in the powder. Sample Si@void@C-2 had a very aggressive etching condition and thus the Si peak at ˜500 cm⁻¹ disappeared. In contrast, Sample Si@void@C-4 had a proper etching condition. As a result, the Si peak at ˜500 cm⁻¹ remained while D and G bands became stronger.

The formation of carbon shells on the surface of Si nanostructured particles has been confirmed via transmission electron microscopy (TEM) analysis. As shown in FIG. 6, the presence of a carbon shell is visible on the surface of many Si nanostructured particles. This carbon shell offers three functions simultaneously: (i) its porous nature allows fast Li⁺ ion transport and thus avoid Li plating on the surface of the carbon shell during extreme fast charging; (ii) it provides a super highway for electron transport to address the low intrinsic electrical conductivity issue of Si; and (iii) it confines the Si volume expansion and shrinkage within the shell during charge/discharge cycling.

### Example 3 (Voltage Profiles of Si Micro-Reactors and their Cycle Stability)

Si micro-reactor particles were mixed with 15 w % of polyacrylic acid (PAA) and 30 w % of carbon black (super P) and then sealed in a glass vial with NMP as solvent and five steel balls as milling media. The mixture was subjected to overnight tumbling at speed of 120 rpm. After tumbling, the electrode slurry became thin and uniform, which was then painted on a copper foil and heated under vacuum at 60° C. for 6 hours and 120° C. for another 6 hours. The dried electrode was then punched into electrode discs and assembled into coin cells with Li chips as the counter electrode. The electrolyte used was LiPF₆ in 1:1 ratio of EC:DEC with addition of 10 vol % FEC and 1 vol % VC.

The charge/discharge voltage profiles of the Si micro-reactor half cell are shown in FIG. 7(a). The coin cell was first charged/discharged with a current density of 0.2 A/g (based on Si weight in the electrode) for 3 cycles and then 100 cycles at 1.0 A/g. The sloping voltage profiles were typical of Si and in good accordance with many published results.

The cycling stability is shown in FIG. 7(b). Clearly, the Si micro-reactors can deliver specific capacity of about 2,500 mAh/g with very good stability over 100 cycles at the current density of 1.0 A/g. This specific capacity is about 6 times the specific capacity of the state-of-the-art graphite anodes. To unambiguously identify the engineered void effect, some carbon-coated Si nanoparticles are used directly without chemical etching (i.e., Si@C particles). As shown in FIG. 7(c), Si@C decays gradually over 100 cycles while also exhibiting lower specific capacities. Therefore, chemical etching to introduce some engineered voids in Si@C to form Si@void@C can greatly improve cycle stability.

### Example 4 (Fast Charging of Si Micro-Reactors and their Cycle Stability)

The Si micro-reactor half cells made in Example 3 were also tested for their high rate charge/discharge capabilities. As shown in FIG. 8(a), Si micro-reactor half cells can deliver about 1000 mAh/g capacity at the current density of 4 A/g over 250 charge/discharge cycles. This capacity is 2.7 times the capacity of the state-of-the-art graphite anode. Further, Si micro-reactor anodes can be charged to the full capacity in 15 min because of their capability to withstand high current density at 4 A/g. None of Li-ion batteries currently on the market can do this because of the Li plating problem at high current densities.

For comparison, commercially available Si nanoparticles high-energy ball milled with 25 wt % PAN and then subjected to carbonization and chemical etching (i.e., nanoSi@void@C) were also been evaluated for their high current density capabilities. As shown in FIG. 8(b), the nanoSi@void@C electrode can also take the current density of 4 A/g over 250 cycles, but the specific capacity continues to decline as the cycle number increases. The poor cycle stability of nanoSi@void@C anode is due to its large particle size distribution (500 nm to 6 μm) as discussed in Example 2.

It is worth mentioning that the quality of carbon shells also plays an important role in the high power capability of Si micro-reactors. FIG. 8(c) shows the cycle stability of a Si@void@C half cell where the carbon shells are formed via carbonization of pyrrole rather than PAN. Clearly, this Si@void@C has very poor cycle stability and only exhibits about 370 mAh/g specific capacity at the current density of 4 A/g after 100 charge/discharge cycles.

### Example 5 (Extreme Fast Charging of Si Micro-Reactors and their Cycle Stability)

The Si micro-reactor half cells made in Example 3 were also tested for their capabilities under extreme fast charging/discharging conditions. As shown in FIG. 9, Si micro-reactor half cells can offer a total of 700 charge/discharge cycles among which 200 cycles are conducted at the current density of 1.5 A/g and 500 cycles at 6 A/g. The specific capacity at 1.5 A/g was about 1,500 mAh/g and at 6 A/g is 1,000 mAh/g. This means that Si micro-reactor anodes can be charged to the full capacity in 10 min and provide a specific capacity of 1,000 mAh/g over 500 cycles. There are no known reports of such performance in any form by any group in the world.

### Example 6 (Mechanisms for Extreme Fast Charging of Si Micro-Reactors)

FIG. 10 compares TEM images of carbon-shell encapsulated Si nanostructured particles before etching (Si@C) and after etching (Si@void@C). It is clear that the Si@C particle is solid because its center is not transparent to the electron beam. In contrast, the Si@void@C particle was porous because its center is transparent to the electron beam, as evidenced by the presence of thickness contrast in the entire particle (i.e., thin regions appear bright and thick regions appear dark). Furthermore, there are no bulky voids and spherical voids inside the Si@void@C particle. Instead, the bright regions manifest as a network, indicating the formation of nano-channeled voids because grain boundaries between nanograins within a nanostructured Si core are a network which is chemically active and etched away first by the NaOH etchant during the etching process.

The engineered voids in the shape of nano-channels play a critical role in the ultrafast charging properties exhibited by Si@void@C electrodes. As shown schematically in FIG. 11, fast charging means that a large number of Li⁺ ions migrate across the porous membrane from the cathode to the Si@void@C anode and these Li⁺ ions should intercalate into the Si core and consume a large number of electrons via reaction (1) very quickly. If Li⁺ ions cannot intercalate into the Si core quickly or a large number of electrons are not available for reaction (1), then Li⁺ ions will accumulate at the Si@void@C anode, leading to significant reduction in the anode potential to below the lithium potential. As a result, Li plating will occur via reaction (2) with dendrite growth which will pose serious problems in terms of reliability and safety of Li-ion batteries. The Si@void@C anode avoids Li plating problem in ultrafast charging because Li⁺ ions can pass through the porous carbon shell quickly and then enter the Si core through the Si particle surface as well as the surfaces of nano-channeled voids. It is well known that surface diffusion is several orders of magnitude faster than diffusion inside a solid. Thus, Li⁺ ions can diffuse rapidly to the center of the Si core through the surfaces of nano-channeled voids and then diffuse into the remaining solids of the Si core from the surfaces of the nano-channeled voids, as shown in FIG. 11. The porous carbon shell also acts as a superhighway for electrons so that rapid Li intercalation into the Si core can be accomplished via reaction (1), preventing reaction (2) and thus Li plating from occurring.

FIG. 12 proves that the Si@void@C anode can indeed be charged and discharged with a current density of 8 A/g. This result demonstrates that Si@void@C with nano-channeled voids can be charged to the full capacity in 3 to 6 minutes with 1,000 cycle stability. Furthermore, at the end of 1,000 cycles the Si@void@C anode still possesses specific capacity (˜400 mAh/g) higher than that of the state-of-the-art graphite anodes (˜370 mAh/g) which typically require ˜3 hours to be fully charged.

Those skilled in the art and guided by the teachings herein provided will understand and appreciate that subject Si micro-reactor anodes with specific capacity of ≥1000 mAh/g can replace the state-of-the-art carbonaceous anodes with specific capacity≤370 mAh/g. It is further envisioned that subject Si micro-reactor anodes can be coupled with the state-of-the-art Li(Ni_{0.5}Mn_{0.3}Co_{0.2})O₂ (NMC532) cathodes such as to obtain high specific energy Li-ion batteries with extremely fast charging capability. Depending on the current density and thus the charging time, the specific energy of the Li-ion battery based on such Si micro-reactor anodes and NMC532 cathodes will vary. The table below summarizes our predicted specific energies for different current densities at the beginning of charge/discharge cycles with less than 20% capacity decay after 500 charge/discharge cycles.

| | | | | Specific |
|---|---|---|---|---|
| | | | | Energy |
| Properties for | | | Average | based on |
| full charge in | | Average | Cell | Si and |
| 2 h | Specific Capacity | Voltage | Voltage | NMC only |
| Anode (Si) | 1,800 mAh/g Si | ~0.2 V | ~3.6 V | 589 Wh/kg |
| | at 0.9 A/g | | | |
| Cathode (NMC) | 180 mAh/g NMC | ~3.8 V | | |
| | at 0.09 A/g | | | |

| | | | | Specific |
|---|---|---|---|---|
| | | | | Energy |
| Properties for | | | Average | based on |
| full charge in | | Average | Cell | Si and |
| 1 h | Specific Capacity | Voltage | Voltage | NMC only |
| Anode (Si) | 1,500 mAh/g Si | ~0.2 V | ~3.6 V | 520 Wh/kg |
| | at 1.5 A/g | | | |
| Cathode (NMC) | 160 mAh/g NMC | ~3.8 V | | |
| | at 0.16 A/g | | | |

| | | | | Specific |
|---|---|---|---|---|
| | | | | Energy |
| Properties for | | | Average | based on |
| full charge in | | Average | Cell | Si and |
| 15 min | Specific Capacity | Voltage | Voltage | NMC only |
| Anode (Si) | 1,000 mAh/g Si | ~0.2 V | ~3.6 V | 413 Wh/kg |
| | at 4.0 A/g | | | |
| Cathode (NMC) | 130 mAh/g NMC | ~3.8 V | | |
| | at 0.52 A/g | | | |

For comparison, if the state-of-the-art graphite anode is coupled with NMC532 cathode, the specific energy based on graphite and NMC is only 402 Wh/kg, as shown in the table below.

| | | | | Specific |
|---|---|---|---|---|
| | | | | Energy |
| Properties for | | | Average | based on |
| full charge in | | Average | Cell | G and |
| 1 h | Specific Capacity | Voltage | Voltage | NMC only |
| Anode | 370 mAh/g G | ~0.2 V | ~3.6 V | 402 Wh/kg |
| (graphite, G) | at 0.37 A/g | | | |
| Cathode (NMC) | 160 mAh/g NMC | ~3.8 V | | |
| | at 0.16 A/g | | | |

In contrast, a subject Si micro-reactor anode coupled with NMC will deliver a specific energy of 520 Wh/kg. Furthermore, the graphite/NMC battery can only be charged to the full capacity in 1 hour or longer. It cannot be charged to full capacity in 10 or 15 min, which will lead to Li plating at the anode and shorting of the battery. However, subject Si micro-reactor anodes do not have this problem and can be charged to the full capacity in only 5 or 15 min, as proven in examples shown above.

The subject development can generally be practiced using micro-sized Si particles 1 to 200 μm in size. As detailed herein, in some embodiments the micro-sized Si particles are 10 to 20 μm in size.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A process for fabricating Si micro-reactors, the process comprising:
high-energy ball milling micro-sized Si particles with a first OPC mixture at first ball milling conditions to reduce the micro-sized Si particles to nanostructured particles and form Si+OPC clusters wherein the Si nanostructured particles are glued together by OPC;
high-energy ball milling the Si+OPC clusters with a second OPC mixture at second ball milling conditions to form a ball milled Si+OPC mixture wherein the Si+OPC clusters are injected into OPC particles;
treating the ball milled Si+OPC mixture at carbon shell formation conditions to convert OPC to carbon shells and to form Si nanostructured particles coated with a carbon shell; and
chemically etching the Si core of the Si nanostructured particles coated with a carbon shell under chemical etching conditions to generate engineering voids inside the carbon shell and to form Si micro-reactors.

2. The process of claim 1 wherein the engineering voids inside the carbon shell are in the shape of nano-channels.

3. The process of claim 1 wherein the micro-sized Si particles comprise particle 1 to 200 μm in size.

4. The process of claim 1 wherein the OPC is PAN.

5. The process of claim 4 wherein the first PAN mixture comprises about 5 wt % polyacrylonitrile.

6. The process of claim 4 wherein the first ball milling conditions comprises ball milling for 3 to 30 hours at ambient temperature under an inert atmosphere.

7. The process of claim 4 wherein the Si+PAN clusters are 1 to 3 μm in size and the Si nanostructured particles are 100 to 500 nm in size and contain nanograins with grain sizes ranging from 5 to 90 nm.

8. The process of claim 4 wherein the second PAN mixture comprises about 10 to 40 wt % polyacrylonitrile.

9. The process of claim 4 wherein the second ball milling conditions comprises ball milling for 1 to 10 hours.

10. The process of claim 4 wherein the treating the ball milled Si+PAN mixture at carbon shell formation conditions comprises heating the ball milled Si+PAN mixture in an inert atmosphere at between 500 to 1000° C. for 1-15 hours.

11. The process of claim 1 wherein the chemical etching conditions comprises chemical etching employing a chemical etchant comprising 0.5M to 1.0M NaOH+10 wt % isopropanol at 20 to 90° C.

12. The process of claim 1 wherein the etched particles are washed and dried.

13. The process of claim 1 wherein the OPC is selected from the group consisting of pitches, rayon, polyvinyl alcohol, polyimides, phenolics, and acetate.

14. A Si micro-reactor formed by the process of claim 1.

15. A lithium ion battery comprising:
an anode comprising Si micro-reactor formed by the process of claim 1.

16. A Si micro-reactor comprising:
a core comprising nanostructured Si building blocks;
a conductive carbon shell disposed around the core; and
a volume of engineered void space within the carbon shell.

17. The Si micro-reactor of claim 16 wherein the engineering void volume within the carbon shell comprises engineering voids in the shape of nano-channels.

18. The Si micro-reactor of claim 16 wherein the Si micro-reactor has an outer diameter ranging from 100 to 500 nm and contains nanograins with grain sizes ranging from 5 to 90 nm.

19. A lithium ion battery comprising:
an anode comprising the Si micro-reactor of claim 16.
